(19) United States
(12) Patent Application Publication
(10) Pub. No.: US 2009/0003603 A1
(43) Pub. Date: Jan. 1, 2009

(54) Platform Independent Networked Communications

(75) Inventors: James Abram Wessel, JR., Seattle, WA (US); Chris Brown, Manhattan Beach, CA (US)

Correspondence Address: FISH & RICHARDSON, PC, P.O. BOX 1022, MINNEAPOLIS, MN, 55440-1022, US

(73) Assignee: Metabeam Corporation, Manhattan Beach, CA (US)

(21) Appl. No.: 12/165,381

(22) Filed: Jun. 30, 2008

Related U.S. Application Data
(60) Provisional application No. 60/947,080, filed on Jun. 29, 2007.

(51) Int. Cl. G06F 21/00; H04K 1/00

(52) U.S. Cl. 380/255; 726/26

(57) ABSTRACT

Among other things, techniques and systems are described for facilitating networked communication among media players of various platforms, PCs with various DVD-ROM drives, mobile data processing devices and one or more network servers. At a network server, a request for communication is received from a client device. A secured network connection is provided with the client device. In addition, the received request is processed. Processing the received request includes, when detecting that the received request is a request for data, retrieving or generating the requested data in a platform-neutral format and sending the retrieved or generated data in a format compatible with the client device. Processing the received request includes, when detecting that the received request is a request to send data to another client device, retrieving or generating the requested data in a platform-neutral format and sending the retrieved or generated data in a format compatible with the other client device.

### CLAIM OF PRIORITY

This application claims priority under 35 USC §119(e) to U.S. Patent Application Ser. No. 60/947,080, filed on Jun. 29, 2007, the entire contents of which are hereby incorporated by reference.

### BACKGROUND

The subject matter described in this specification relates to techniques for facilitating networked communications among media players of various platforms and types (all digital media e.g., fixed, optical, packaged media, downloadable, mobile), mobile data processing devices and one or more network servers. In particular, the subject matter described in this specification relates to techniques for facilitating networked communications among various digital media players such as Blu-ray players PCs with DVD-ROM drives, digital video recorders and other set top media players, gaming consoles and mobile data processing devices through a common network server.

Typically, digital media players such as Blu-ray players or PCs with DVD drives, gaming consoles and mobile media players include capabilities to perform networked communication with a network server. For instance, a website specially generated by a movie studio may provide information related to a particular movie recorded on the Blu-ray medium. Due to the specific data format of the Blu-ray platform, the website and the information provided in the website tend to be accessible or compatible only with Blu-ray players (or a PC with a Blu-ray disc drive). A similar situation exists for PCs with DVD playback mechanisms, and some general purpose devices that have standard DVD playback mechanisms, such as Media Center PCs.

### SUMMARY

Systems and techniques are disclosed for facilitating networked communications among media players of different platform, PCs with DVD-ROM drives, mobile data processing devices and one or more network servers.

In one aspect, at a network server, a request for communication is received from a client device. A secured network connection is provided with the client device. In addition, the received request is processed. Processing the received request includes, when detecting that the received request is a request to send data to the requesting client device, selectively retrieving or generating the requested data in a platform-neutral format and sending the retrieved or generated data in a format compatible with the requesting client device. Processing the received request includes, when detecting that the received request is a request to send data to another client device, selectively retrieving or generating the requested data in a platform-neutral format and sending the retrieved or generated data in a format compatible with the other client device.

Implementations can optionally include one or more of the following features. When the requested data does not exist, the requested data can be selectively generated. When the requested data does exist, the requested data can be selectively retrieved. Providing the secured network connection with the client device can include identifying a server authentication certificate located at the client device. Providing the secured network connection can include configuring the network server based on the identified server authentication certificate to prepare the network server to respond to the request for communication. Configuring the network server can include configuring the network server to communicate with the client using Hypertext Transfer Protocol (HTTP) server configuration for Transport Layer Security (TLS). Alternatively, providing the secured network connection with the client device can include generating a server authentication certificate based on the format compatible with client device; and authenticating the network server based on the generated certificate to prepare the network server to respond to the request for communication. Also, in response to the received request for communication, digital content located at the client device can be authenticated. Authenticating includes receiving from the client device data that includes client device generated Secure Hash Algorithm hash code associated with the digital content; and validating the received hash code. Validating the received hash code can include validating at least one of SHA-1, SHA-224, SHA-256, SHA-384, and SHA-512 hash code. In addition, a client session can be authenticated with the client device based on an authentication header corresponding to the format compatible with the client device. Further, unauthorized access to copyrighted digital content can be restricted by encapsulating the generated or retrieved data using an encapsulation format and sending the encapsulated data to the requesting client device. Receiving the request for communication can include receiving a platform indicator appended to the request, wherein the received platform indicator identifies the format compatible with the client device. Also, processing the received request for communication can include converting the retrieved or generated data from the platform-neutral format to the format compatible with the client device or the other client device based on the received platform indicator appended to the request.

In another aspect, a system can include a network; and a network server in communication with one or more client devices over the network. The network server includes a transceiver unit configured to receive from the one or more client devices a request for communication that includes at least one of a request to receive data and a request to send data to another client device. The network server also includes a server authentication unit configured to provide a secured network connection with the one or more client devices. The network server further includes a platform branching unit configured to retrieve or generate the requested data in a platform-neutral format. The platform branching unit is also configured to convert the retrieved or generated data in a format compatible with the client device when detecting that the received request is a request to send data to the requesting client device. When detecting that the received request is a request to send data to the other client device, the platform branching unit is configured to convert the retrieved or generated data to a format compatible with the other client device.

Implementations can optionally include one or more of the following features. When the requested data does not exist, the requested data can be selectively generated. When the requested data does exist, the requested data can be selectively retrieved. The server authentication unit can be configured to provide the secured network connection with the one or more client devices, by having the server authentication unit configured to identify a server authentication certificate provided by the client device; and configure the network server based on the identified server authentication certificate to prepare the network server to respond to the request for communication. The server authentication unit can be configured to prepare the network server to communicate with the one or more client devices using Hypertext Transfer Protocol (HTTP) server configuration for Transport Layer Security (TLS). The server authentication unit can be configured to provide the secured network connection with the one or more client devices by having the server authentication unit configured to generate a server authentication certificate based on the format compatible with client device; and authenticate the network server based on the generated certificate to prepare the network server to respond to the request for communication. The network server can further include a data authentication unit configured to authenticate digital content located at the one or more client devices. The data authentication unit can be configured to authenticate the digital content by having the data authentication unit further configured to receive from the one or more client devices data that includes client device generated Secure Hash Algorithm hash code associated with the digital content; and validate the received hash code. The data authentication unit can be configured to validate the received hash code by validating at least one of SHA-1, SHA-224, SHA-256, SHA-384, and SHA-512 hash code. The server authentication unit can be further configured to authenticate a client session with the one or more client devices based on an authentication header corresponding to the format compatible with the one or more client devices. The network server can include a content distribution unit configured to restrict unauthorized access to copyrighted digital content. The content distribution unit can be further configured to encapsulate the generated or retrieved data using an encapsulation format; and send the encapsulated data to the one or more client devices. The transceiver can be configured to receive a platform indicator appended to the received request, wherein the received platform indicator identifies the format compatible with the one or more client devices. The platform branching unit can be configured to convert the retrieved or generated data from the platform-neutral format to the format compatible with the one or more client devices or the other client device based on the received platform indicator appended to the request.

In yet anther aspect, a computer program product, embodied on a computer readable medium, is operable to cause a data processing apparatus to perform operations of the techniques and systems as described in this specification.

The subject matter described in this specification potentially can provide various advantages. In particular, networked communication among media players of various platforms, mobile data communication devices, PCs with various DVD-ROM drives and one or more network servers are enabled. In general, interfacing or communicating with a media player device or a PC containing a media player device tend to be limited by a particular data format and/or infrastructure corresponding to the media player's platform (e.g., X-Box Live, Sony PlayStation Network, Tivo, Blu-ray, etc.). Thus, while a particular media player device (e.g., Xbox 360, Playstation, Tivo, Blu-ray player, etc.) may be capable of conducting networked communication (e.g., using a network interface, such as a wireless network adaptor), the networked communication for the media player tends to be limited to a particular network server compatible with the media player platform. In addition, due to the incompatibility among the different media player platforms (e.g., DVD-ROM, Blu-ray, etc.), media players of different platforms may not be able to communicate with each other. Further, media players may be precluded from communicating with other data processing devices. The subject matter described in this specification can provide a set of client (e.g., media player) and server (e.g., network server) components designed to support networked communication between Blu-ray players or PC's with DVD-ROM drives, or gaming consoles or mobile media devices and a common server infrastructure using one or more protocols (e.g., the SOAP, REST or XML-RPC protocol), with the objective of creating a simple and widely-applicable method of implementing network support for the new high-definition content playback environments as well as for compliant SD-DVD-ROM implementations and mobile media device playback environments.

The subject matter described in this specification can be implemented as a method or as a system or using computer program products, tangibly embodied in information carriers, such as a CD-ROM, a DVD-ROM, a Blu-ray disc drive, a semiconductor memory, and a hard disk. Such computer program products may cause a data processing apparatus to conduct one or more operations described in this specification.

In addition, the subject matter described in this specification can also be implemented as a system including a processor and memory coupled to the processor. The memory may encode one or more programs that cause the processor to perform one or more of the method acts described in this specification. Further the subject matter described in this specification can be implemented using various data processing machines.

### BRIEF DESCRIPTION OF DRAWINGS

FIG. 1 is a block diagram of a system for enabling networked communications among media players of various platforms, PCs with various DVD-ROM drives, mobile data processing devices and one or more network servers.

FIGS. 2a and 2b represent a process flow diagram of a process for enabling networked communications between a client device and a network server.

FIGS. 3a and 3b represent a process flow diagram of a process for enabling networked communications between a first client device and a second client device.

FIG. 4 is a block diagram of a network system for providing a secured networked communications.

FIG. 5 represents a process flow diagram of a process for providing a secured network connection to a client device.

FIG. 6 represents a process flow diagram of a process for providing disc authentication.

FIG. 7 is a process flow diagram representing a process for performing content distribution within a content security protocol.

FIG. 8 is a process flow diagram of a process for branching among different platforms.

Like reference symbols in the various drawings indicate like elements.

### DETAILED DESCRIPTION

The following describes techniques for facilitating networked communications among media players or various platforms, PCs with various DVD-ROM drives, mobile data processing machines and one or more network servers.

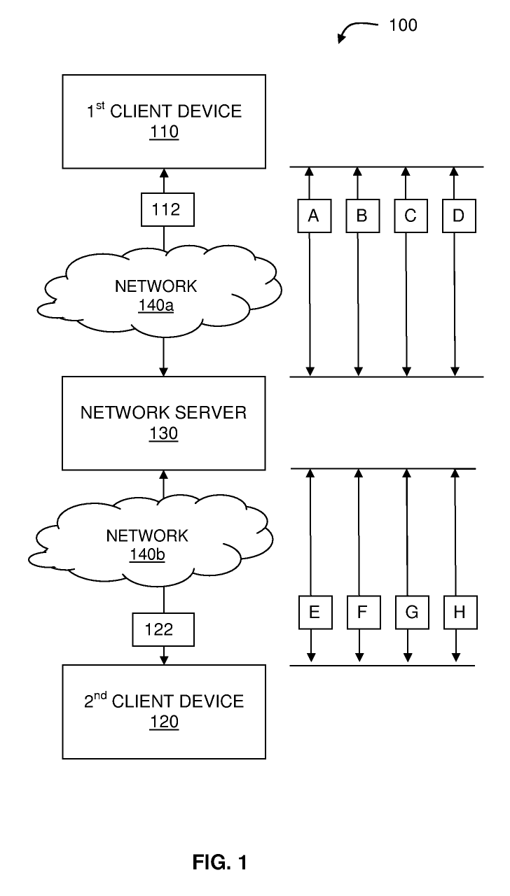

FIG. 1 represents a block diagram of a system 100 for facilitating networked communications among media players of various platforms, PCs with various DVD-ROM drives, mobile data processing machines and one or more network servers. The system includes one or more client devices 110 and 120 communicatively linked to a network server 130 using one or more bidirectional communication links 112 and 122. The client devices 110 and 120 include media players of various platforms (e.g., gaming console, Blu-ray player, etc.), a PC with a DVD-ROM drive (e.g., BD-ROM, DVD ROM, etc.) and a mobile data processing device (e.g., mobile phone, smart phone, PDA, etc.). The communication links 112 and 122 are designed to enable or provide communication over one or more networks 140a and 140b such as a local area network (LAN), wide area network (WAN), WiFi, WiMAX, Internet, etc. For example, the communication links 112 and 122 can include a wireless network adaptor, a radio receiver/transceiver combination, a modem, etc.

The communication links 112 and 122 enable various data communications between a client device 110 or 120 and the network server 130. For example, a request for data (A) from a first client device 110 can be received, over a network 140a, and processed by the network server 130. In response the request (A) from the client device 110, the requested data (B) can be transmitted to the requesting client device 110 in a format compatible with the requesting client device 110. Similarly, a second client device 120 can also request data (E), over a network 140b, from the network server 130. Again, in response to the request (E), a corresponding requested data (F) is transmitted back to the requesting client device 120 in a format compatible with the requesting client device 120. The requested data can include various digital content (e.g., ringtone, video, audio, text, etc.)

In addition, the communication links 112 and 122 enable various data communications between a first client device 110 and a second client device 120. For example, at the network server 130, a request (C) from a first client device 110 can be received, over a network 140a, to communicate with a second client device 120. The network server 130 processes the information and relays (G) the request (C) to the target second client device 120. When the network server detects that the first client device 110 is a media player of a first platform (e.g., PC DVD-ROM player) and the target second client device 120 is a media player of a second platform (e.g., Blu-ray player), the network device processes the request (C) and transmits the request (C) in a format compatible with the target second client device 120. Similarly, a request (H) can be received from the second client device 120 to communicate with the first client device 110. The request (H) from the second client device is processed and relayed (D) to the target first client device 110 in a format compatible with the first client device 110.

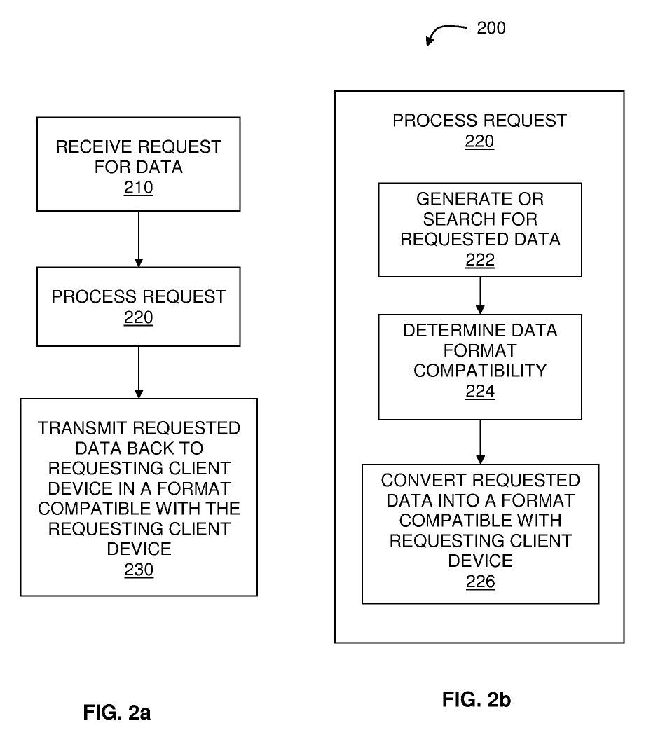

FIGS. 2a and 2b represent a process flow diagram of a process 200 for enabling communication between a client device 110 or 120 and a network server 130. At 210, a network server 130 receives a request for data from a client device 110 or 120. The requested data is processed at 220. Processing the request 220 can include generating or searching 222 for the requested data. The requested data is obtained in a platform-neutral format. Also, the data format compatibility of the requesting client device is determined at 224. For example, a determination is made whether the client device is a PC DVD-ROM player or a Blu-ray player. When the requested data is generated or located by searching various other network servers and/or databases, the requested data is converted from the platform-neutral format into the determined format at 226. The requested data converted into a format compatible with the requesting client device is transmitted to the requesting client device at 230.

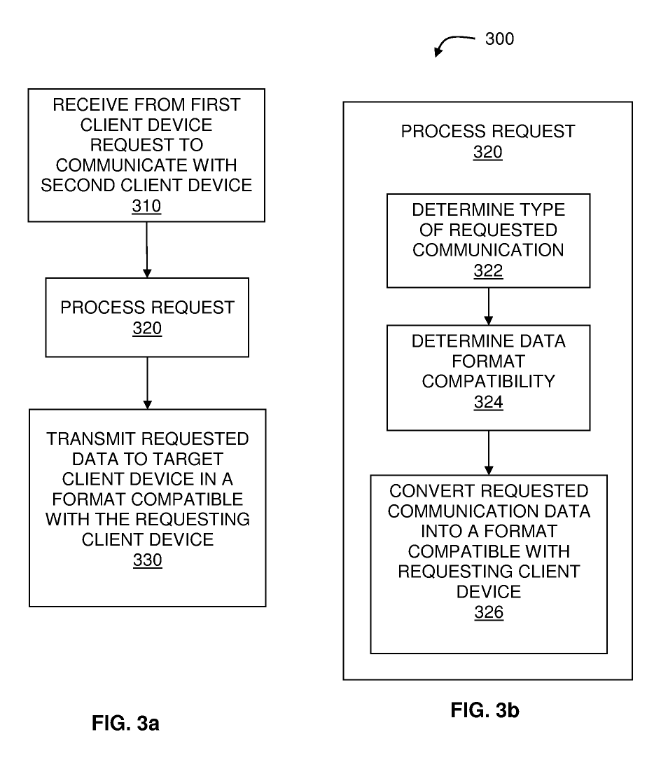

FIGS. 3a and 3b represent a process flow diagram of a process for enabling communication between a first client device 110 and a second client device 120. At 310, a network server 130 receives a request for communication from a client device 110 or 120. The requested communication is processed at 320. Processing the request 320 can include determining a type of communication requested. For instance, the type of communication requested can include a request to send a text message such as instant message, e-mail, SMS, etc. to a target client device. In some instances, the requested communication can include a request to transmit content (e.g., image, video, audio, ringtone, etc.) to the target client device. Also, the data format compatibility of the target client device is determined at 324. For example, a determination is made whether the requesting client device and the target client device are compatible with a PC DVD-ROM player or a Blu-ray player. When the requesting client device is compatible with PC DVD-ROM player data format, the request for communication (e.g., a text message) will be in a PC DVD-ROM compatible format. The requested test message is then converted (e.g., by transcoding or a software programming language translation mechanism or software data transformation mechanism, e.g. XSLT, etc.) into a format compatible with the target client device. When determined that the target client is compatible with a different format from the requesting client device, the requested communication data is converted into the determined format of the target client device at 326. The requested data converted into a format compatible with the target client device is transmitted to the requesting client device at 330.

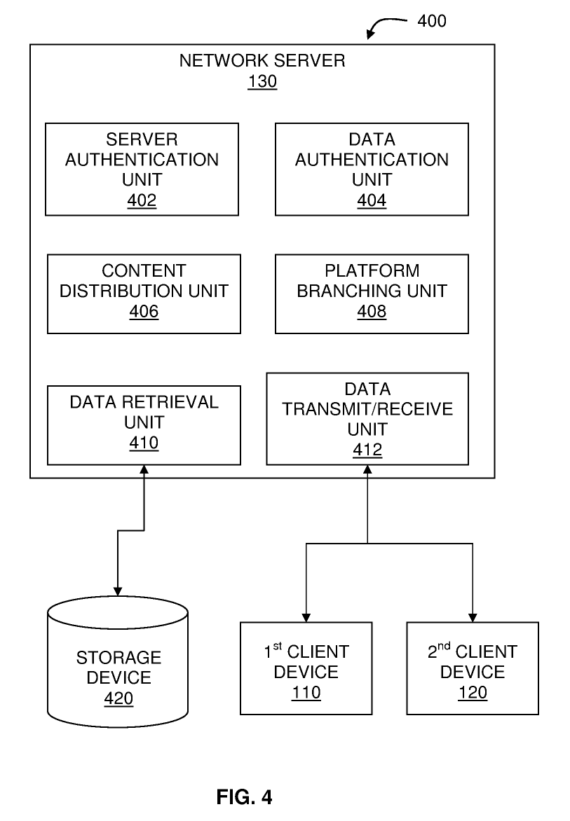

FIG. 4 is a block diagram of a network system 400 for enabling secured networked communications. The network system 400 includes one or more client devices 110 and 120 (e.g., media player such as Blu-ray; PCs with DVD-ROM; or portable data processing devices such as PDA, smart phone, etc.) and a network server 130. The network server 130 can include network server components designed to support networked communication between various client devices (e.g., Blu-ray players or PC's with DVD-ROM drives), and a common server infrastructure using a portable data protocol e.g. SOAP or REST, etc. The network server components can be implemented to create a simple and widely-applicable process of enabling network support for high-definition DVD environments as well as for compliant SD-DVD-ROM implementations.

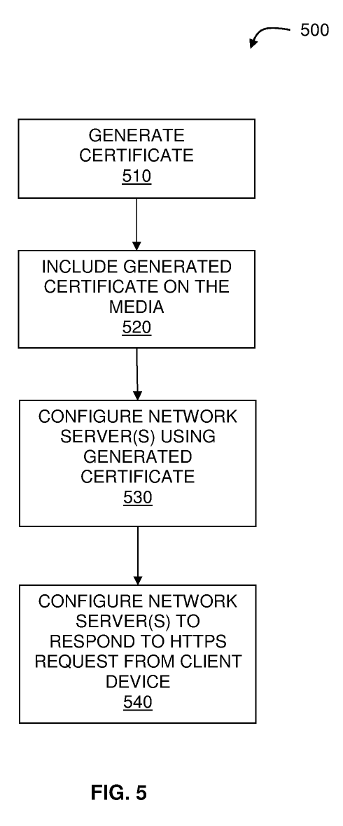

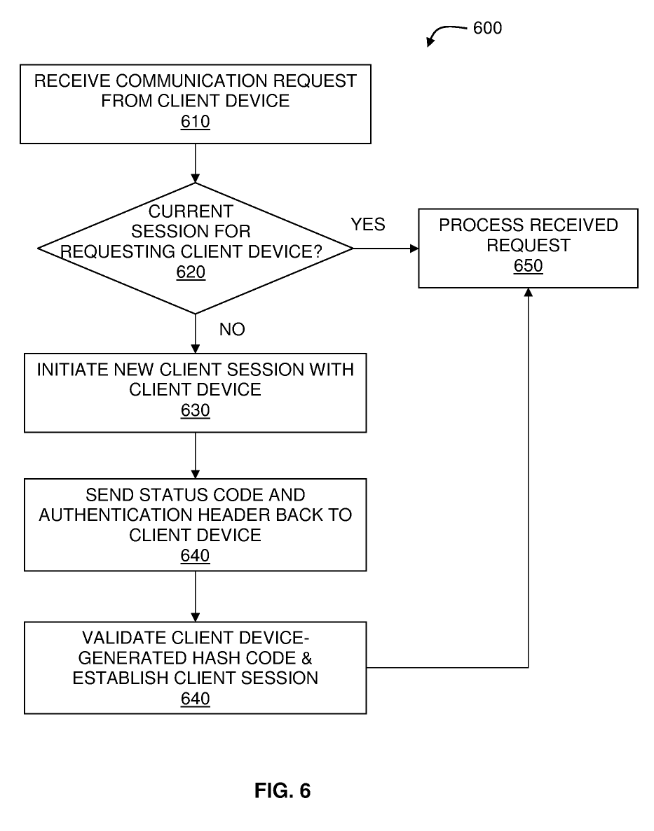

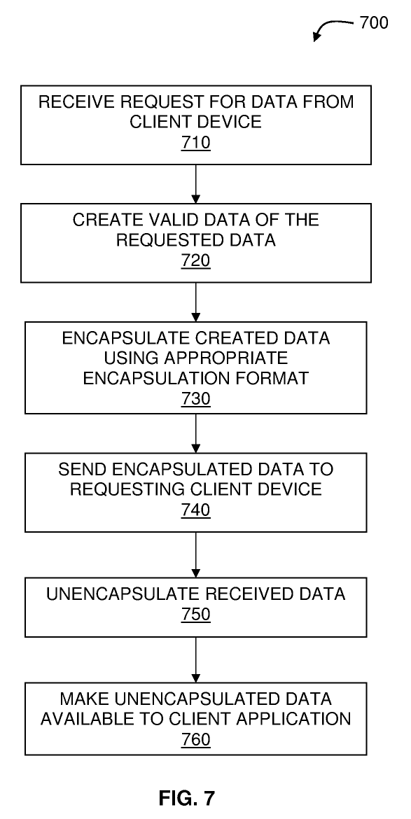

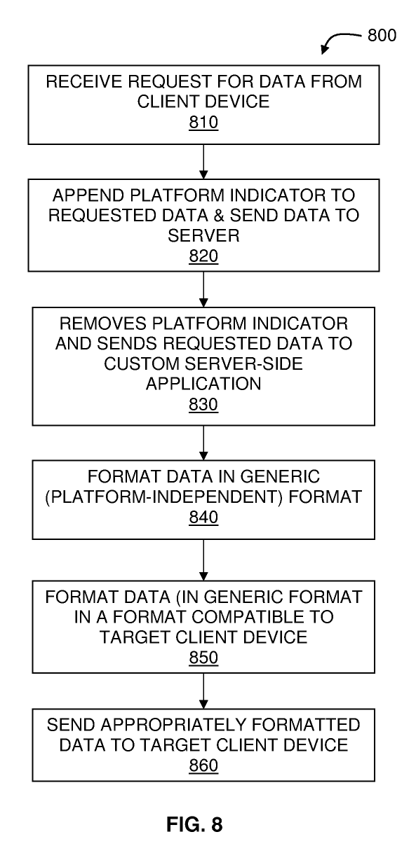

The network server components can include among others, a server authentication unit 402, a data authentication unit 404, a content distribution unit 406, a platform branching unit 408, a data retrieval unit 410 and a data transmit/receive unit 412. The server authentication unit 402 enables a secure network connection as described with respect to FIG. 5 below. The data authentication unit 404 enables added security by authenticating the media (e.g., the disc) using disc authentication protocol as described with respect to FIG. 6 below. The content distribution unit 406 enables encapsulation of the requested data to restrict unauthorized access (e.g., using content security technologies) as described with respect to FIG. 7 below. The platform branching unit 408 enables cross-communication between client devices of different platforms (e.g., PC DVD-ROM and Blu-Ray) as described with respect to FIG. 8 below. The data transmit/receive unit 412 can be implemented as a transceiver that enables the network server to receive and/or send data to/from one or more client devices 110 and 120. The data received and sent between the network server and the client devices include the request for communication received from the client devices and any response sent from the network server to the client devices.

In some implementations, the network system also includes a storage device 420 such as network database. The data retrieval unit 410 can obtain data requested by one or more client device 110 and 120 by communication with the storage device 420.

Security-Server Authentication

FIG. 5 represents a process flow diagram of a process 500 for providing a secured network connection to a client device. A secured network connection to a client device such as Blu-Ray Players and PC's with DVD-ROM drives can be implemented using Hypertext Transfer Protocol (HTTP) server configuration for Transport Layer Security (TLS) using certificates that are present on a media (e.g., the Blu-ray disc). If the server certificate is not present on the media or in permanent storage on the client device, the user can be provided with an option to connect to the network server based on trusting the certificate provider. TLS authentication is a standard feature of Web server software, e.g. Apache, IIS, etc. and no additional components are required to support TLS. The server authentication unit 402 can include complete instructions for configuring a network server 130 (e.g., a Web server) for Server Authentication according to the Blu-ray Disc specification or other platform specifications. At 510, a certificate appropriate for the data platform (e.g., Blu-ray) is generated. The generated certificate is included on the media disc (e.g., Blu-ray) at 520. One or more network servers (e.g., Apache or IIS or other web servers) are configured using the generated certificate at 530. The configured network servers are further configured to respond to an HTTPS request from a client device at 540.

Server authentication for a DVD-ROM can be implementation-dependent. DVD-ROM server authentication methods compatible with a standard network architecture can be implemented using the server components provided with a toolkit.

Security-Disc Authentication

FIG. 6 represents a process flow diagram of a process for providing disc authentication. To provide an additional level of security, a networking framework can be implemented to provide network components to support an optional Disc Authentication protocol for network servers of various platforms such as IIS and Apache web servers. Among other things, a data authentication unit 404 can includes various components such as the Internet Server Application Programming Interface (ISAPI) Disc Authentication component for Internet Information Services (IIS)/Windows. In particular, a data authentication unit 404 can include a disc authentication component (e.g., ISAPI Disc Authentication component for_IIS/Windows) that maintains client sessions and disc authentication. At 610, a communication request (e.g., an HTTP request) is received from a client device 110 or 120. In response to the request, the Disc Authentication component first checks at 620 to determine whether there is a current session for the requesting client device 110 or 120 using an authorization header provided by the requesting client device 110 or 120. At 630, when a current session for the requesting client device 110 or 120 is not found, a new client session is initiated at 630. The Disc Authentication component sends a status code and an authentication header (e.g., a 401 status code and WWW-Authenticate header) back to the client device 110 and/or 120 at 640. The authentication header is generated specifically for each disc based on disc-specific (e.g., Blu-ray) configuration data stored on the network server 130. When a subsequent request from the client 110 or 120 is sent with the WWW-Authorization header, the Disc Authentication component validates the client device-generated Secure Hash Algorithm (SHA) hash code (e.g., SHA-1, SHA-224, SHA-256, SHA-384, and SHA-512 hash code) and establishes a client session at 650. When a currently running client session is found, the received request is processed at 650.

The data authentication unit 404 can also be compatible with various other platforms. For example, a CGI Disc Authentication component for Apache/Linux can be implemented. The CGI Disc Authentication component can provide Disc Authentication services for Apache on Linux using a similar process 600 as described with respect to the IIS version.

Disc authentication for DVD-ROM is implementation-dependent. DVD-ROM disc authentication methods compatible with the network system 400 can be implemented using the server components (e.g., 402, 404, 406, 408, 410 and 412) provided with a Toolkit.

Object Access Protocol Support

A network system (e.g., 100 and 400) can include source code compatible with various platforms including IIS and Apache-compatible source code for providing communication links between various client devices and network servers. For example, basic Simple Object Access Protocol (SOAP) transactions can be implemented. SOAP is a protocol for exchanging XML-based messages over computer networks using an Internet application layer protocol as a transport protocol, such as Simple Mail Transfer Protocol (SMTP) and HTTP. SOAP may also be implemented over secure HTTP (HTTPS). HTTPS is essentially the same protocol as HTTP at the application level, but adds an encrypted transport protocol underneath between the HTTP and the Transmission Control Protocol (TCP). The REST protocol, which implements similar methods, could also be used to provide communication links between various client devices and network servers.

The source code for basic SOAP transaction includes the following:

(1) Player-to-server XML upload.

(2) Server-to-player XML download using player-initiated polling (“pull”).

(3) Player-to-player communication using player-initiated polling (“pull”).

(4) Player to remote-device communication using RSS.

(5) Player to remote-device communication using SMS_(text messaging).

(6) Remote device to player communication using WAP.

(7) Remote device to player communication using other mobile phone network data protocols.

(8) Control of player with mobile device.

(9) Content download using SOAP with Attachments/MIME for Web Services.

Content Binding for Real-Time Playback

Content binding for seamless/real-time playback of networked content can also be provided. Content binding is platform-dependent, feature-dependent and disc-dependent. Real-time playback operation can be enabled using the network system 100 and 400 as the transport mechanism. In addition, feature-specific operations may also be implemented by using additional programming.

Client-Side Features

The network system 100 or 400 includes various components on the client device 110 or 120. The client-side components include client-side libraries and code to support networking communication on various platforms e.g., Blu-ray Disc Java (BD-J) using SOAP and XML. Specific client-side features include:

(1) Methods for creating a secure authenticated connection between the player and web service.

(2) Methods for creating and sending a SOAP envelope.

(3) Methods for accessing SOAP/XML data from a web-service.

(4) Methods for downloading binary content from a web-service.

Advanced Access Content System (AACS) Encapsulation:

AACS is a standard for secure content that can regulate copying and accessing content stored in the next generation of optical discs and DVDs such as Blu-ray. Transactions between the network server 100 or 400 and one or more client device 110 and 120 can be further secured by restricting unauthorized access to copyrighted content using a content distribution unit 406. FIG. 7 is a process flow diagram representing a process 700 for performing secure content distribution. At 710, a network server receives a request for data from a client device. At 720, the network server creates valid data (e.g. SOAP XML envelope and data). At 730, the network server encapsulates the created data using the appropriate encapsulation format (For XML, the format is Encapsulation Format for Hash or in Encapsulation Format for Encryption and Hash depending on whether the data is encrypted.) If the data is encrypted, the server must have the Title Key for the disk. At 740, the network server sends the encapsulated data to the requesting client device. At 750, the requesting client device unencapsulates the received encapsulated data and (if necessary) decrypts the data. At 760, the unencapsulated (and possible decrypted) data is made available to an application running on the client device in raw (unencapsulated) format.

All of the client device operations can be executed before the data is made available to the application, in which case, client-side codes are not needed to read the data. The network server 100 or 400 is further designed to support the encapsulation/encryption capabilities, which comprises the bulk of the work in creating server support for networking.

Further, support for encapsulation and encryption can be implemented as part of a networking toolkit used to implement the network system 100 and 400. For dynamic data, encapsulation is handled at the toolkit level to enable any application using the toolkit to avoid implementing its own support for encapsulation. In some implementations, the toolkit enables an application to manage data independent of the platform-specific requirements, and have the network application program interfaces (APIs) handle the communication to the client device 110 and 120.

Platform Branching

FIG. 8 is a process flow diagram of a process for branching among different platforms (e.g., between PC DVD-ROM and Blu-ray) to allow client devices of different platforms to communicate with each other. A platform branching unit 408 on the network server 130 can include toolkit extensions that enables custom application codes on the client device 110 or 120 or the network server 130 to operate without needing to implement platform-specific operations. At 810, a client device requests data from the server using a toolkit client-side object model. At 820, a toolkit client-side object model appends a platform indicator to the request and passes the request to the server. At 830, the network server removes the platform indicator and sends the request to a custom server-side application (e.g., a Web service). At 840, a custom server-side application obtains the requested data and formats the data in a generic or platform-neutral (not platform-specific) format. At 850, server-side toolkit extensions format (e.g., by transcoding or software transformation) the requested data (now in a generic format) in an appropriate format compatible with the target client device. For example, if the target client device is a Blu-ray player, the requested data is formatted in Blu-ray compatible format. At 860, the network server sends the appropriately formatted data to the target client device.

A generic common data format enables simplification of the process of adding support for new platforms (e.g., Blu-ray) by implementing translation (or conversion) functions from a platform format to the generic format and vice versa. This eliminates the need to write translation functions between every possible combination of devices/platforms. In addition, the generic data format allows the system to potentially perform operations on the data in a single format (the generic format) rather than having to support those operations for all possible formats. For example, the system might provide some built-in caching capability to improve performance. It is simpler to write a caching mechanism that only has to know about one data format than to write it for all formats. Further, using the generic format serves to define the common supported feature set between disparate devices. There may be features which are not compatible with all devices. For example, it may not be feasible to display a full-screen Blu-ray image on a cell phone. Using a generic data format allows the system to define a minimum set of features that must be supported on all platforms, and handling for features that may be supported only on a sub-set of platforms.

Support for Server-Side Applications

Server-side applications are designed to operate as Web services. Specific integration mechanism may depend on various design factors. In some implementations, no specific integration requirement is needed, and the server-side application simply operates with no specific requirements. For example, all platform-dependent requirements are handled by an extension of the Web-server that sits in between the Web service and the client device. Alternatively, one or more requirements to read and write data is implemented using a custom component incorporated into the server application. In all instances, additional code required to interact with the each client device of each platform are minimized or eliminated.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. A “machine-readable medium” includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein does not require the particular order shown, or sequential order, to achieve desirable results. Other embodiments may be within the scope of the following claims.

A number of implementations of the disclosure have been described. Nevertheless, it will be understood that various modifications may be made without departing from the scope of the disclosure including the claims.

What is claimed is:

1. A method comprising:
at a network server, receiving from a client device a request for communication;
providing a secured network connection with the client device; and
processing the received request, wherein the processing comprises:
when detecting that the received request is a request to send data to the requesting client device, selectively retrieving or generating the requested data in a platform-neutral format and sending the retrieved or generated data in a format compatible with the requesting client device, and
when detecting that the received request is a request to send data to another client device, selectively retrieving or generating the requested data in a platform-neutral format and sending the retrieved or generated data in a format compatible with the other client device.

2. The method of claim 1, wherein selectively retrieving or generating comprises:
when the requested data does not exist, selectively generating the requested data; and
when the requested data does exist, selectively retrieving the requested data.

3. The method of claim 1, wherein providing the secured network connection with the client device comprises:
identifying a server authentication certificate located at the client device; and
configuring the network server based on the identified server authentication certificate to prepare the network server to respond to the request for communication.

4. The method of claim 3, wherein configuring the network server comprises: configuring the network server to communicate with the client using Hypertext Transfer Protocol (HTTP) server configuration for Transport Layer Security (TLS).

5. The method of claim 1, wherein providing the secured network connection with the client device comprises:
generating a server authentication certificate based on the format compatible with client device; and
authenticating the network server based on the generated certificate to prepare the network server to respond to the request for communication.

6. The method of claim 1 further comprising:
in response to the received request for communication, authenticating digital content provided by the client device, wherein the authenticating includes:
receiving from the client device data that includes client device generated Secure Hash Algorithm hash code associated with the digital content; and
validating the received hash code.

7. The method of claim 6, wherein validating the received hash code comprises validating at least one of SHA-1, SHA-224, SHA-256, SHA-384, and SHA-512 hash code.

8. The method of claim 1, further comprising authenticating a client session with the client device based on an authentication header corresponding to the format compatible with the client device.

9. The method of claim 1, further comprising:
restricting unauthorized access to copyrighted digital content, wherein the restricting includes
encapsulating the generated or retrieved data using an encapsulation format; and
sending the encapsulated data to the requesting client device.

10. The method of claim 1, wherein receiving the request for communication comprises:
receiving a platform indicator appended to the request, wherein the received platform indicator identifies the format compatible with the client device.

11. The method of claim 10, wherein processing the received request for communication comprises:
converting the retrieved or generated data from the platform-neutral format to the format compatible with the client device or the other client device based on the received platform indicator appended to the request.

12. A system comprising:
a network; and
a network server in communication with one or more client devices over the network, wherein the network server comprises
a transceiver unit configured to receive from the one or more client devices a request for communication that includes at least one of a request to receive data and a request to send data to another client device;
a server authentication unit configured to provide a secured network connection with the one or more client devices; and
a platform branching unit configured to
retrieve or generate the requested data in a platform-neutral format;
convert the retrieved or generated data in a format compatible with the client device when detecting that the received request is a request to send data to the requesting client device; and
convert the retrieved or generated data in a format compatible with the other client device when detecting that the received request is a request to send data to the other client device.

13. The system of claim 12, wherein the platform branching unit is configured to selectively generate the requested data when the requested data does not exist; and selectively retrieve the requested data when the requested data does exist.

14. The system of claim 12, wherein the server authentication unit configured to provide the secured network connection with the one or more client devices comprises having the server authentication unit configured to:
identify a server authentication certificate located at the client device; and
configure the network server based on the identified server authentication certificate to prepare the network server to respond to the request for communication.

15. The system of claim 14, wherein the server authentication unit is configured to configure the network server to communicate with the one or more client devices using Hypertext Transfer Protocol (HTTP) server configuration for Transport Layer Security (TLS).

16. The system of claim 12, wherein the server authentication unit configured to provide the secured network connection with the one or more client devices comprises having the server authentication unit configured to:
generate a server authentication certificate based on the format compatible with client device; and
authenticate the network server based on the generated certificate to prepare the network server to respond to the request for communication.

17. The system of claim 12, wherein the network server further comprises:
a data authentication unit configured to authenticate digital content located at the one or more client devices.

18. The system of claim 17, wherein the data authentication unit is configured to authenticate the digital content by having the data authentication unit further configured to:
receive from the one or more client devices data that includes client device generated Secure Hash Algorithm hash code associated with the digital content; and
validate the received hash code.

19. The system of claim 18, wherein the data authentication unit is configured to validate the received hash code comprising validating at least one of SHA-1, SHA-224, SHA-256, SHA-384, and SHA-512 hash code.

20. The system of claim 12, wherein the server authentication unit is further configured to authenticate a client session with the one or more client devices based on an authentication header corresponding to the format compatible with the one or more client devices.

21. The system of claim 12, wherein the network server comprises a content distribution unit configured to restrict unauthorized access to copyrighted digital content.

22. The system of claim 21, wherein the content distribution unit is further configured to:
encapsulate the generated or retrieved data using an encapsulation format; and
send the encapsulated data to the one or more client devices.

23. The system of claim 12, wherein the transceiver is configured to receive a platform indicator appended to the received request, wherein the received platform indicator identifies the format compatible with the one or more client devices.

24. The system of claim 23, wherein the platform branching unit is configured to convert the retrieved or generated data from the platform-neutral format to the format compatible with the one or more client devices or the other client device based on the received platform indicator appended to the request.

25. A computer program product, embodied on a computer readable medium, operable to cause a data processing apparatus to perform operations comprising:
at a network server, receiving from a client device a request for communication;
providing a secured network connection with the client device; and
processing the received request, wherein the processing includes
when detecting that the received request is a request to send data to the requesting client device, selectively retrieving or generating the requested data in a platform-neutral format and sending the retrieved or generated data in a format compatible with the requesting client device, and
when detecting that the received request is a request to send data to another client device, selectively retrieving or generating the requested data in a platform-neutral format and sending the retrieved or generated data in a format compatible with the other client device.

26. The computer program product of claim 25, operable to cause a data processing apparatus to selectively generate the requested data when the requested data does not exist; and when the requested data does exist, selectively retrieving the requested data.

27. The computer program product of claim 25, operable to cause a data processing apparatus to provide the secured network connection with the client device comprising:
identifying a server authentication certificate located at the client device; and
configuring the network server based on the identified server authentication certificate to prepare the network server to respond to the request for communication.

28. The computer program product of claim 27, operable to cause a data processing apparatus to configuring the network server to communicate with the client device using Hypertext Transfer Protocol (HTTP) server configuration for Transport Layer Security (TLS).

29. The computer program product of claim 25, operable to cause a data processing apparatus to provide the secured network connection with the client device comprising:
generating a server authentication certificate based on the format compatible with client device; and
authenticating the network server based on the generated certificate to prepare the network server to respond to the request for communication.

30. The computer program product of claim 25, operable to cause a data processing apparatus to perform the following:
in response to the received request for communication, authenticating digital content located at the client device, wherein the authenticating includes:
receiving from the client device data that includes client device generated Secure Hash Algorithm hash code associated with the digital content; and
validating the received hash code.

31. The computer program product of claim 30, operable to cause a data processing apparatus to validate the received hash code comprising validating at least one of SHA-1, SHA-224, SHA-256, SHA-384, and SHA-512 hash code.

32. The computer program product of claim 25, operable to cause a data processing apparatus to authenticate a client session with the client device based on an authentication header corresponding to the format compatible with the client device.

33. The computer program product of claim 25, operable to cause a data processing apparatus to perform operations comprising:
restricting unauthorized access to copyrighted digital content, wherein the restricting includes
encapsulating the generated or retrieved data using an encapsulation format; and
sending the encapsulated data to the requesting client device.

34. The computer program product of claim 25, operable to cause a data processing apparatus to receive a platform indicator appended to the request, wherein the received platform indicator identifies the format compatible with the client device.

35. The computer program product of claim 34, operable to cause a data processing apparatus to process the received request for communication comprising:
converting the retrieved or generated data from the platform-neutral format to the format compatible with the client device or the other device based on the received platform indicator appended to the request.
